(19) United States
(12) Patent Application Publication
(10) Pub. No.: US 2011/0091859 A1
(43) Pub. Date: Apr. 21, 2011

(54) Method for Online Learning

(76) Inventor: David A. Hall, South Pasadena, CA (US)

(21) Appl. No.: 12/582,006

(22) Filed: Oct. 20, 2009

(51) Int. Cl. G09B 7/00

(52) U.S. Cl. 434/350; 434/362

(57) ABSTRACT

A curriculum is created aligned closely to the state standards. This is broken down into tiny units called factoids, analogous to atoms in chemistry. The factoids are converted into question-and-answer pairs. These are placed on electronic flashcards so that they can be sorted according to the degree of mastery. There is a question on one side and an answer on the other. They are answered mentally. A user/student can choose from the options “Show again: Today, A, B, C, or Never” depending on his/her understanding of the question. A software system remembers each student as an individual and the status of each flashcard that the student has attempted to answer. There are five tiers in the classification system: school> year> subject> topic> and subtopic. A subtopic would contain from 10 to 100 flashcards depending upon the grade level.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates to a method of Internet learning of a large mass of material (such as 12th grade) that is much faster (by a factor of 7), more thorough (you can't get through the program without mastering the entire curriculum), more economical than traditional methods (by a factor of 10,000) and more enjoyable for the students than conventional practices.

### BACKGROUND OF THE INVENTION

The present invention recognizes the inefficiency of bricks and mortar education and the inevitable transition to online learning for the majority of students. The invention solves a number of problems that must be addressed in making this transition. The users (students), parents and facilitators, and school officials are always able to quickly and easily see the overall student progress as well as the level of short-term activity of the student in real time. One of the many ways that we are meeting accountability needs is through the integration of retention tests and a Dashboard for easy tracking of student progress. For a school to be truly successful in educating its students, it is critical that all of the information taught be incorporated into the long-term memory of the student and that this process be entirely verifiable. The present invention meets both of these needs with efficiency.

### SUMMARY OF THE INVENTION

The present invention is a method for the Internet learning of a large body of knowledge or course of study. We have formed the conclusion that all information, from preschool to law school, is divisible into fact units, analogous to atoms in chemistry. We begin by establishing a curriculum of study. We then break it down into what we term as “factoids.” These are then converted into question and answer pairs. These are then placed on electronic flashcards so that they can be sorted by the student according to the degree of mastery. There is a question on one side and an answer on the other. They are answered mentally. Students answer the questions mentally, and then indicate when they want to see them again from today, a number of days, or never. (There are five choices.) A software system remembers each student as an individual and the status of each flashcard that the student has attempted to answer. There are five tiers in the classification system: school> year> subject> topic> and subtopic. Only subtopics contain flashcards. A subtopic would contain from 10 to 100 flashcards depending upon grade level. For example, preschool subtopics contain 10 flashcards while high school subtopics contain 50 flashcards. Students work with one subtopic at a time and cycle through the flashcards until they have all been eliminated.

Multiple-choice tests are presented at the end of each subtopic to hold the student accountable for using the flash cards correctly without cheating. If the student does not pass the test, the flashcards are reset. Reset means that the memory is erased for that subtopic so that as far as the computer is concerned, the student never worked with the flashcards at all in that subtopic.

Immediately upon answering a multiple-choice test question, the student would be shown an explanation. If the question was answered incorrectly, the correct answer would not be given, but rather the reason that the selected answer was wrong. The system would also remember responses to test questions. The test questions mentioned above would test short-term memory. Approximately two-six weeks later, a random set of test questions would be presented to the student from the same pool. The quiz might contain test questions from more than one subtopic and at random. If the test questions were answered correctly they would be displayed less frequently at a later time. Long-term test questions that were missed would be shown again repeatedly at random over several week intervals until they were answered correctly on two separate occasions separated by at least six weeks.

A parent/teacher control panel would display the status of the student at a glance. This would be in two sections: the first would show the grade level of the student for each subject. The second would show what the student had accomplished on a daily basis for the previous week. The system would track time spent per day using the system, number of flashcards viewed, number of flashcards answered correctly, long-term and short-term tests passed, test scores, as well as test questions answered correctly. A fingerprint analyzer and 360° camera could be used to verify the identity of the student. These are available combined in a small device attached to the computer and are not expensive.

Students would be tested at the beginning of the program. They would receive their results and be given advice regarding the best place to start in the system. For example if the student was in ninth grade, but only doing sixth grade level math, he would be advised to start in sixth grade math in order to build a proper foundation. The student would choose his level in each subject instead of being forced to work at the same level in different subjects in which his mastery might not be the same.

The flashcards would only teach one fact unit at a time. That is, they would only expect the student to give one fact unit in the answer. This allows the student to separate with precision what he knows from what he does not know. Occasionally an answer might contain more than one fact unit, as in the case of a definition. Breaking answers down into fact units makes the system as easy to use as possible.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1. illustrates a typical short term learning test application chart taught by the present invention;

FIG. 2 illustrates a typical long term learning test application chart taught by the present invention;

FIG. 3 illustrates a sample retention test question, with user response selected taught by the present invention;

FIG. 4 illustrates a sample incorrect retention test answer, with explanation of inaccurate answer taught by the present invention;

FIG. 5 illustrates a sample dashboard front page showing basic statistics for each user;

FIG. 6 illustrates a detailed dashboard view taught by the present invention;

FIG. 7 illustrates the four interrelated phases of learning with the present invention;

FIG. 8 illustrates a Card Front;

FIG. 9 illustrates a Card Back;

FIG. 10 illustrates a Card Front after answer has been shown; and

FIG. 11. illustrates a progress report generated by a user request to view a subject review.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. In the present invention, students begin the learning process by cycling through the virtual flashcards of a subtopic until the information presented has been incorporated into short-term memory, as determined by the subjective judgment of the student. After self-reporting successful completion of a subtopic, or content area strand, the student is presented with the option of additional flashcard review or proceeding to an objective assessment of the material presented in the given subtopic. Students electing to review the subtopic flashcards will be able to randomize the flashcard order, which more closely mirrors the format of the tests and which reduces the likelihood of a student using information presented on a recently shown card to help answer a question correctly. After accurately responding to the flashcards during the review, students must proceed to the short-term test. These end-of-subtopic tests serve as a measure of content comprehension.

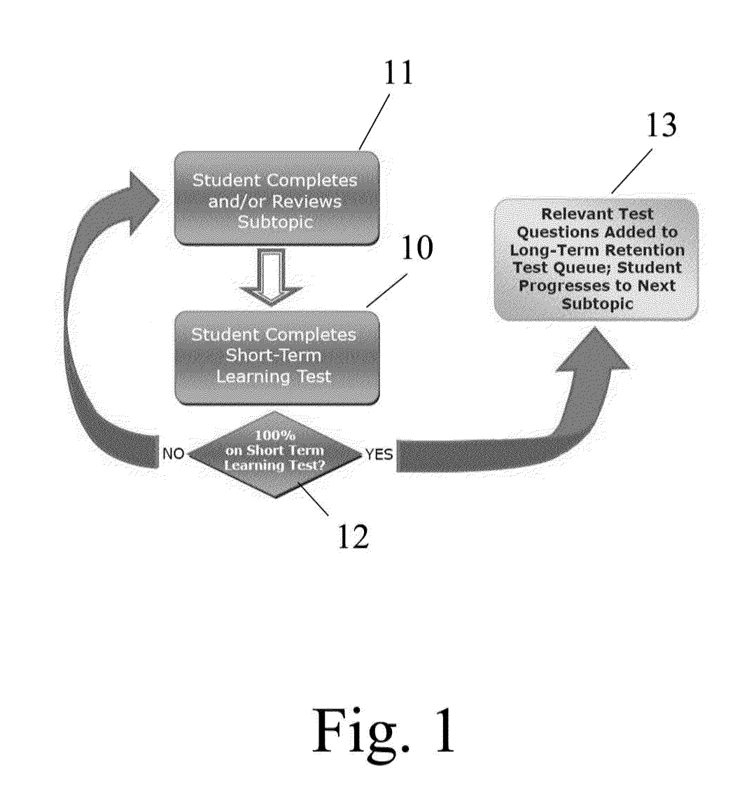

As shown in FIG. 1, the student must complete a multiple-choice short-term learning test 10 before moving to a new subtopic in the tested subject area. Performance on the short-term assessment 12 determines whether the student is returned to the subtopic flashcards 11 for further review 11 or may progress to the next subtopic 13. Even a single missed question on the short-term learning test 10 requires the student to return to the subtopic 11. This is not viewed as failure on the part of the student; rather it is a means to prevent future failure. Small gaps in learning can be very easily corrected if caught early, and only become a problem if they become ingrained.

If a student correctly answers all questions on the short-term learning test 10, the student will then be invited to move to the next subtopic 13. However, in the present invention students are carefully advised on the importance of long-term mastery of all information taught. Students are encouraged to review subtopics if they felt unsure of any test answers, even if the correct answers were ultimately chosen.

The process of completing subtopics, taking subsequent short-term learning tests, reviewing when necessary, and participating in ongoing learning continues exclusively for the first four weeks of learning with the present invention. At this time, long-term multiple-choice tests are then added to the process 20. These new tests, referred to as Long-Term Retention Tests, serve to ensure that course content is fully incorporated into the student's long-term memory. Much like the flashcards, the long-term test questions are tracked by the database.

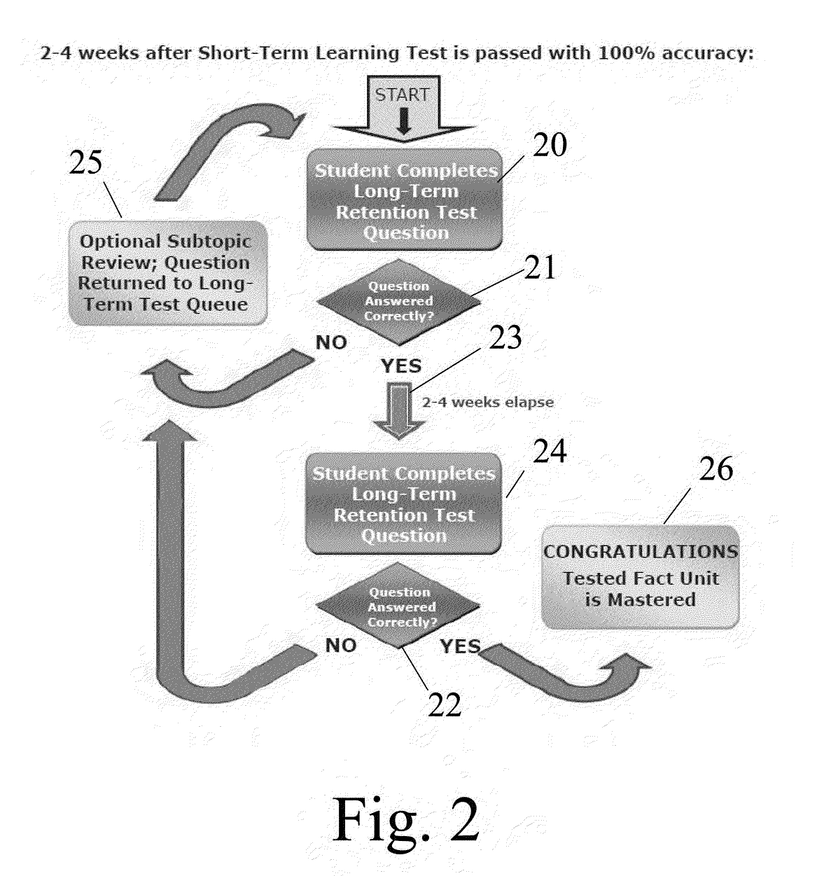

New retention tests are added to each student's queue on an ongoing basis. The system custom-designs retention tests to prioritize questions, targeting content that has been most frequently missed on previous exposures. Retention test questions 20 and 24 are presented to the student at intervals of no less than two weeks 23. When the student correctly answers retention test questions on two consecutive occasions 21 and 22, the fact unit tested is considered to be mastered 26 as shown in FIG. 2. Students may still opt to return to previously mastered flashcards at any time 25, though such action is rarely needed. This cyclical model of learning, with opportunity for immediate remediation of any and all skill gaps, elevates the present invention above other systems of education. Further, the automaticity ensures that tests can be effectively customized and tracked for thousands of students simultaneously.

Both Short-Term Learning Tests and Long-Term Retention Tests utilize the same test questions. However, test questions used in the Short-Term Learning Tests exclusively represent content from the subtopic previously studied, while the Long-Term Retention Tests are a summative grouping of random questions weighted toward questions that have been previously answered incorrectly. The randomization of Long-Term Retention Test questions is critical in ensuring that a student answers each question based on knowledge of the fact being tested and does not draw upon information previously presented in the test. The basic unit of a Long-Term Retention Test is thus the test question rather than the entire test.

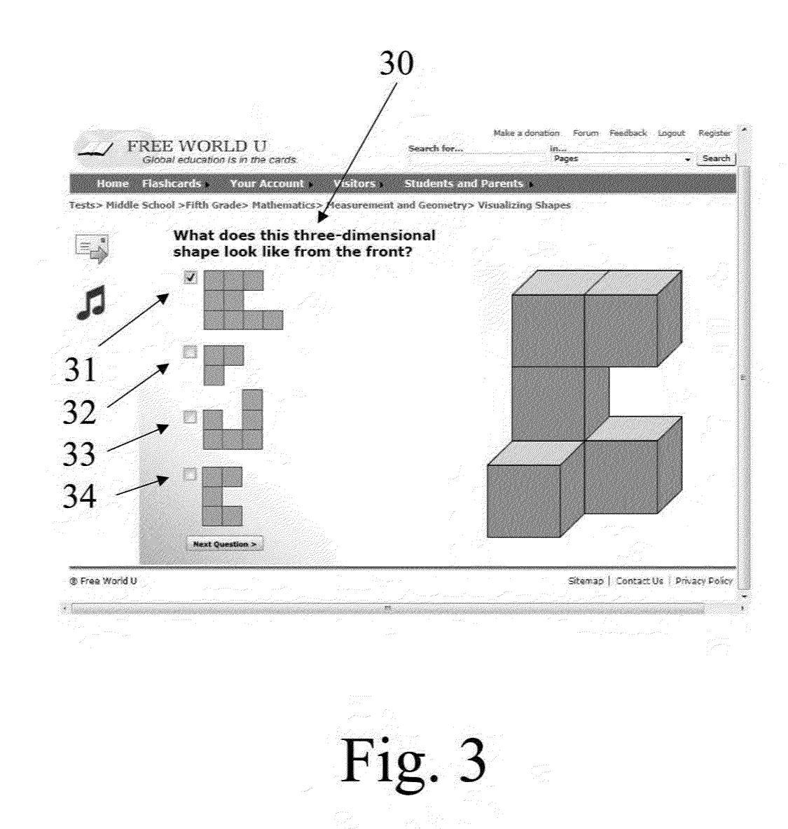

All test questions are developed for the present invention using the rigorous process initially designed for flashcard creation. Each question is able to stand-alone and tests only one discrete fact unit. Test questions 30 are multiple-choice, containing four possible responses 31, 32, 33, and 34 as shown in FIG. 3.

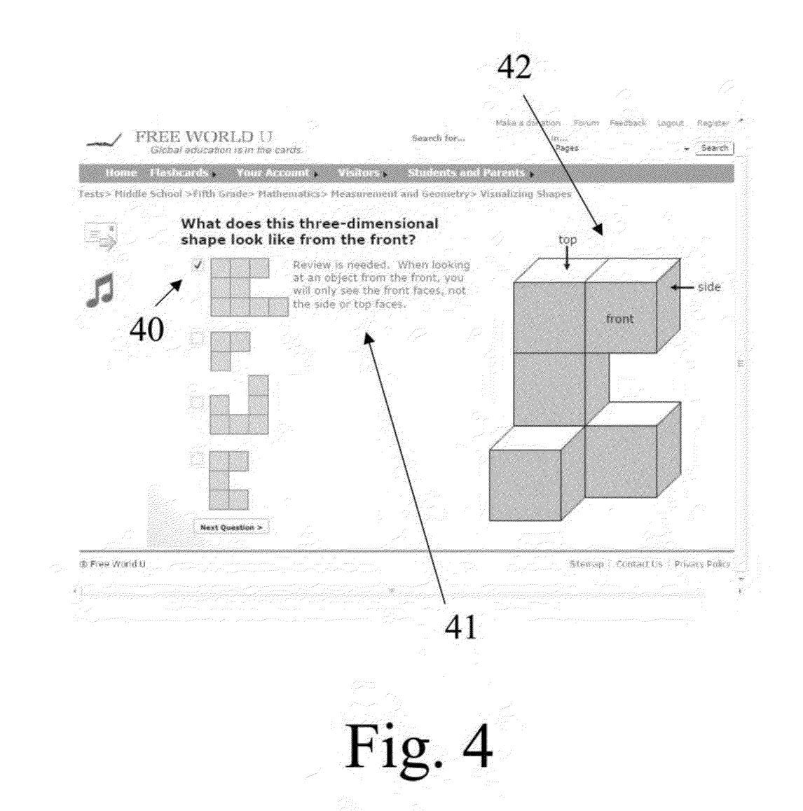

Immediately upon answering a test question 40, an explanation 41 and 42 regarding the accuracy or inaccuracy of each answer will be displayed to the student as shown in FIG. 4. This instant feedback about the student's performance on tests increases the educational value of the assessment, encouraging each student to assimilate the additional information about the missed test question(s) at a time that the student is mostly likely to recall why the selected answer was chosen. The student can then incorporate the feedback into his/her understanding of the subject matter, ultimately adding the corrected cognition to long-term memory.

Responses that meet the mastery criteria of two consecutive correct answers 21 and 22 are automatically removed from the future assessments. Each incorrect answer on an assessment is not only immediately explained, but the student is also offered the opportunity to review the content material at that time 25. In conventional education, students are routinely promoted from one grade to the next even when known to possess significant skill gaps. The process of ensuring that each and every fact unit presented in the present invention curriculum is mastered before a student may complete the program makes the present invention a most rigorous educational organization. The efficient use of review makes the program extraordinarily effective.

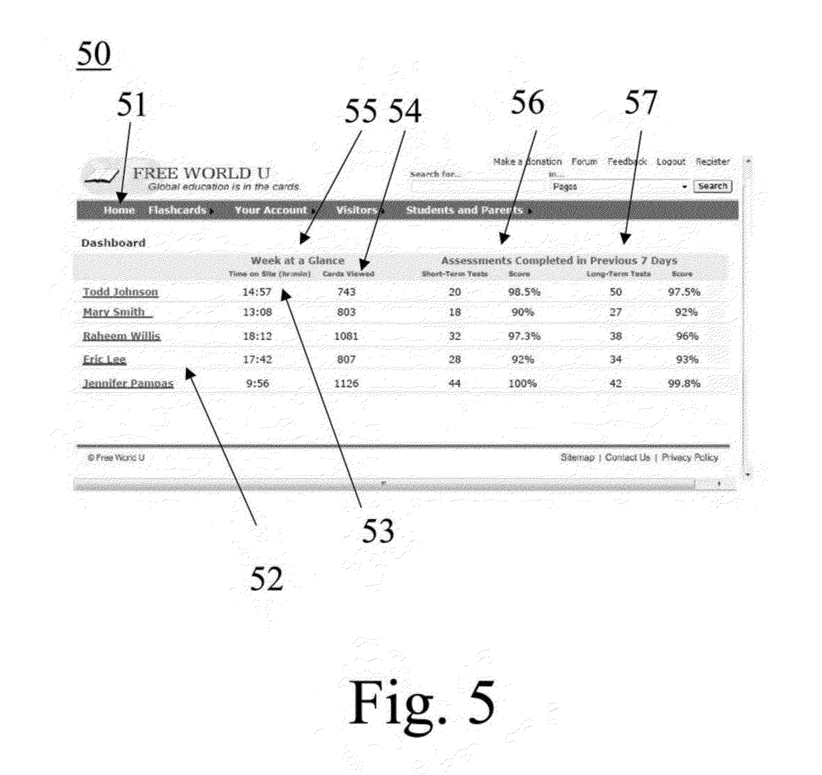

Student responses to retention test questions will be itemized and presented as part of the Dashboard 50 as shown in FIG. 5, facilitating tracking of student performance. The first page 51, or home page, of the Dashboard 50 will list each of the students 52 affiliated with the parent or teacher. The first two columns 53 and 54 beside each student's name display basic usage statistics for the prior seven days. Included in this “Week at a Glance” table 55 is the amount of time each user spent learning on the present invention site in the past week 53, and the number of cards that each student viewed in that time 54. Information about the tests, both short-56 and long-term 57, completed in the prior seven days is also included on the Dashboard 50 home page 51.

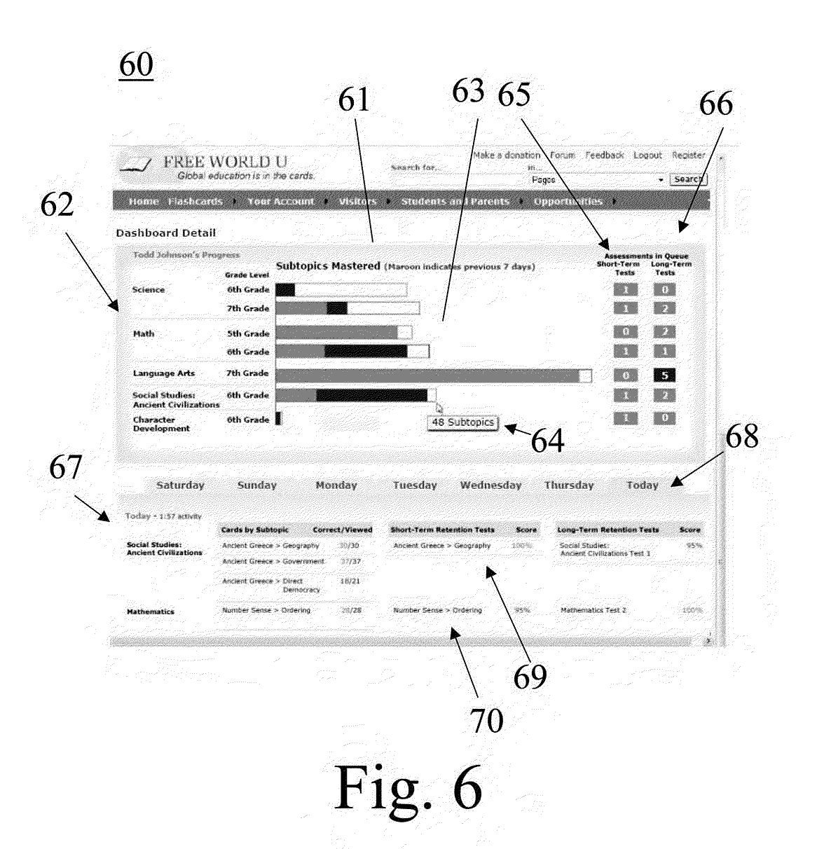

When a parent or teacher desires additional information about a student's performance for the week, a detailed progress inventory 60 as shown in FIG. 6 may be viewed via a single click on the student's name.

The Dashboard Detail page 60 provides a comprehensive inventory of current student progress. At the top of the Dashboard Detail page is a display 61 showing the total number of subtopics completed 63 for any open subject 62. Those subtopics 62 completed in the past seven days are differentiated with highlighting. Using the example in FIG. 6, the Dashboard Detail 61 shows that fictitious student Todd Johnson is currently working in both 6^{th} and 7^{th} grade Science.

When a student has difficulty at one grade level, he has been instructed how to navigate to prior knowledge subtopics to remedy existing skill gaps. Thus it is not unexpected for a student to be simultaneously working in multiple grade levels within a subject. Moving one's cursor over the Subtopics Mastered bar graph on the Dashboard will produce a text box identifying how many subtopics are represented at that point in the graph, helping the parent or teacher judge the student's pacing. For example, the arrow 64 at the end of the 6^{th} grade Social Studies bar graph in FIG. 6 shows that there are 48 total subtopics in 6^{th} grade Social Studies: Ancient Civilizations.

The Dashboard example illustrated in FIG. 6 also shows that Todd has an incomplete Short-Term Learning Test 65 in his queue for 6^{th} grade science, but no long-term tests 66. This is consistent for a student who has recently opened a subject; by their definition, Long-Term Retention Tests will not be administered until at least 2-to-3 weeks has passed from the date the short-term assessment was successfully completed. Once a student has been working in a subject for some time, the ratio of short-term to long-term tests generally reverses.

Short-Term Learning Tests are designed to be completed as soon as a subtopic is finished. There will not be more than one Short-Term Retention Test per subject and grade level in a student's queue, as a student may not progress to a subsequent subtopic until the completed subtopic's short-term test is answered with 100% accuracy. In the FIG. 6 example, the bottom portion of the Dashboard 67 shows that student Todd Johnson has completed two Short-Term Learning Tests 69 and 70 “Today” 68 and that he may need additional practice with Number Sense shown by highlighting of 95% score.

Long-Term Retention Tests are not added to a student's queue until substantial time has passed from the time that the material is first introduced. Like short-term tests, Long-Term Retention Tests are also intended to be taken soon after being assigned. If a student does not complete retention tests in the days immediately following assignment, the queue will become overly-full with tests. The student will then need to suspend flashcard learning in order to complete the tests. In the FIG. 6 example, the number of Grade 7 Language Arts Long-Term Retention Tests, 5, is highlighted. This highlighting alerts the parent or teacher viewing the Dashboard that the student is not keeping up with his retention tests. Consistent use of the Dashboard will give the adult responsible for facilitating the student's learning ample opportunity to intercede if a student is not completing retention tests as required to avoid a backlog that could threaten to interrupt learning.

Pacing of learning and testing is especially important for students participating in the present invention Charter School, as these students must have all grade level flashcards completed six weeks prior to the end of the school year. The charter school students will spend the final weeks of their year finalizing retention tests and correcting any skill gaps that are present. Students who have mastered all grade level material will use the time to engage in learning of elective subjects or by moving into the next grade level material.

Home schooled students and those who are using the present invention to supplement other formal schooling may be less concerned with pacing than their charter school counterparts. Regardless, all parents and teachers will have the option of activating a pacing guide, found under the user account settings. The pacing guide will outline targets for subtopic completion dates in order to reach a predetermined goal, such as completion of core grade level material by a given date. The pacing guide will be of great assistance to students with significant skill gaps. Such students will begin instruction far below grade level, and are expected to move rapidly through the early material. As the students reach grade level material, the rate of subtopic mastery typically decreases. This is customary, and not of concern.

Student mastery of subtopics is also more rapid when students first begin learning with the present invention, because there are no Long-Term Retention Tests to be taken. The lack of long term tests frees additional time for flashcard learning, and the pace of subtopic mastery is rapid until long-term tests are assigned. If a parent sets a mastery goal based upon the initial rate of subtopic completion, the student may have difficulty reaching that goal; the pacing guide helps to establish a realistic rate at which a student should work to meet the end-of-year goals.

The Dashboard allows students to maintain autonomy in selecting subtopic pacing, determining when review is needed, and in deciding when to complete assessments. Such independence is important for character development. Through monitoring of the Dashboard, parents and teachers are able to determine when students are making sound decisions regarding their educational progress, and when adult guidance may be required. As such, students grow in their confidence and their independence without ever being “left behind” in their education.

The innovative cyclic approach to learning developed by the present invention, in which students are constantly eliminating any skill gaps present and engaged in active learning, makes the organization uniquely qualified to correct educational deficits present and lead all learners to true academic success. Learning with the present invention starts with flashcard-based curriculum delivery. Students are responsible for their own pacing, allowing them to move quickly through content that is easy for them while taking the extra time necessary to fully comprehend more challenging material. Every single fact unit is tested using objective measures, eliminating the possibility of students progressing through grade levels while gaps in mastery exist: a phenomenon that has become the norm in traditional education. The objective design of tests in the present invention combined with 100% accuracy requirements for mastery guarantee that students truly understand the material before progressing to subsequent skills within a subject. Randomizing the order of test questions and prohibiting access to previously viewed questions eliminates any chance that students will use test questions already answered to help determine subsequent answers in tests. Minimizing the use of strategy and instead focusing on content mastery elevates the present invention above its peers in authenticity of assessments.

Consistent review requirements following any missed test questions combined with immediate access to any material previously presented gives students tutoring at their fingertips, day or night. No longer will students be pushed onward before comprehension is achieved just because the class is moving forward. When the students have demonstrated comprehension on Short-Term Learning Tests 71 with the present invention, active learning continues with subsequent subtopic instruction 72. Students use the content recently learned as they progress through a grade level. Long-Term Retention Tests 73, administered at established intervals, make certain students have incorporated the learned material into their long-term memory. Any gaps shown are corrected through immediate review of instructional material. Two consecutive correct responses are required before a fact unit is considered mastered. As such, all learning becomes quantifiable and verifiable.

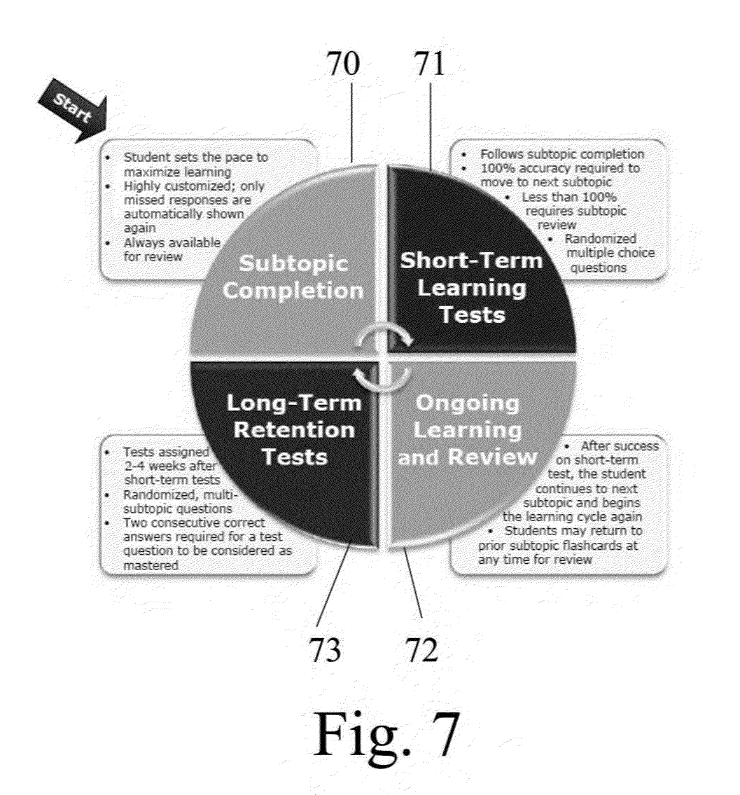

As illustrated in FIG. 7, students are constantly involved in active learning and authentic assessment, and fluidly pass from one phase of the learning continuum to another. Review 72 is instantaneously possible from any phase 70, 71, or 73 and mastery requires success at every phase. As such, the present invention has developed the ultimate system of learning; one that will level the playing field and elevate the standards for all students, and bring possibilities previously unimaginable to the youths of today.

The Website would be the first thing that users see when they connect to the present invention. This site will be comprised of roughly 70 static HTML pages and would be the base of the entire project. The flashcard application would be an extension of this. The site would give users an overview regarding the application and its uses. It would also cover other matters such as information on the organization, its terms of use, policies, help section, etc.

To organize the massive number of flashcards envisioned for the site, a categorization scheme has been developed. A five-tier system is in place. The tier system is as follows: School (largest tier), Year, Subject, Topic, Subtopic (smallest tier). Only subtopics contain flashcards. The tier structure would consist of a series of drill-down menus so in order to see a flashcard; the user would have to make his selection in the above order beginning with School. On selecting each tier, the sub-tiers under it would be displayed. For example, on selecting a Subject, the topics under that subject would be displayed in a list for Topics.

Once a user has drilled into a particular category, there will be several ways for a user to go to another category. From the school category on, users will see a breadcrumb indicating his/her location within the system. This will look like: School> Term> Subject. Or, if he is at the Topic level then he would see the following breadcrumb: School> Term> Subject> Topic. By clicking at any category level, a student will be able to go back to that level and view the categories below. The user will also be able to select “Browse Schools” at any time from the main menu bar to be taken to the broadest view of the site's tier structure.

The option to go to the last flashcard viewed is also available to the students. When a student returns for a new study session, she/he can return to the last flashcard viewed with a single mouse click from the home page. Within the flashcard view itself, the user will have additional options for viewing the various categories available. Once the Subtopic has been selected, the user shall proceed to view the flashcards under that Subtopic. Each flashcard would contain a single question. The flashcards would be shown to users in numerical order by default but registered users have the option of viewing flashcards either in numerical order or randomly. If a subtopic has no cards, the user can't enter that subtopic.

There will be a way to present different curricula to different students (i.e. organize the same subtopics in various ways). For instance, a student in NY may need algebra in 8^{th} grade while a student in CA may need it in 9^{th} grade. The actual content for each student would essentially be the same but the tiers under which each subtopic is presented would need to change. This would be best achieved by having various category levels point to the same subtopic of cards. The category scheme available to a given student should be determined and modifiable by an admin.

Flashcards will be stored in a database. The database of questions could reach into the millions. The program needs to be capable of handling this volume of information as well as flexible enough to deal with an increasingly large database. Users would not have to login to access flashcards if they wanted to sample the program, however the computer would not record their responses.

Upon entering a subtopic with cards, the site would show users a flashcard (in other words a question). Users would mentally answer the question and then click on the ‘Show Answer’ link. The site would now show them the answer. The user would then select the time interval when the flashcard would be shown again, if at all. The display of a question on one webpage and the answer on another webpage mimics the two sides of a physical flashcard.

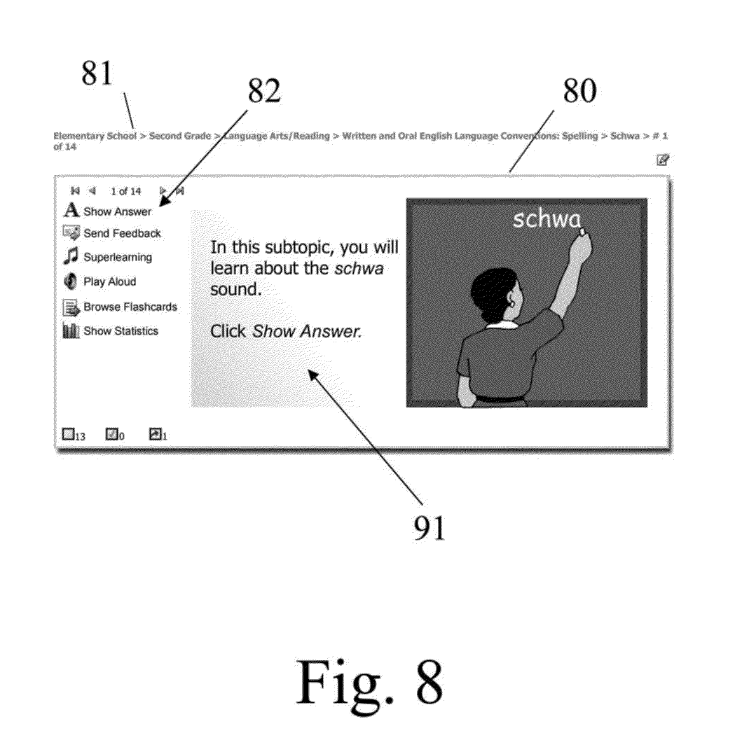

FIG. 8 illustrates a Card Front

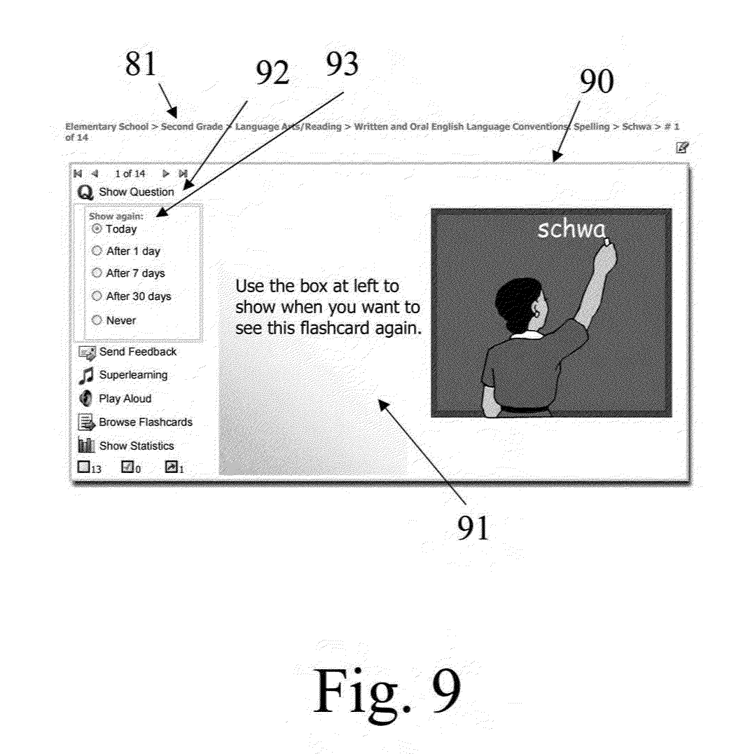

FIG. 9 illustrates a Card Back

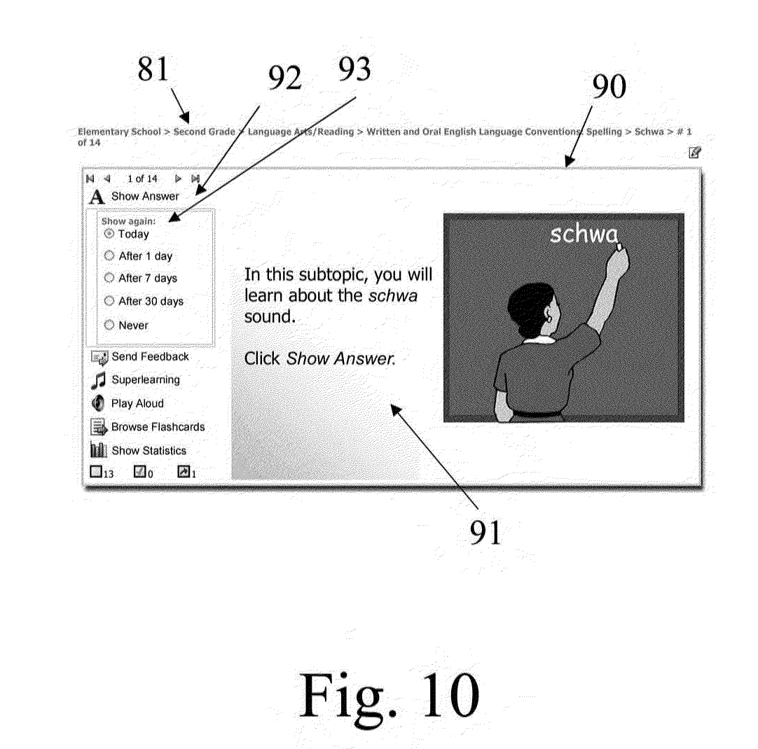

FIG. 10 illustrates a Card Front after answer has been shown

If the user has a weak understanding of the subject matter, the flashcard would be sent to the “bottom” of the set of flashcards for that Subtopic and would, in time, come up by rotation and would be presented again to the student. If the user has turned on the randomize option, the program would not include the incorrect flashcard in its pool of flashcards to choose from until the designated time has passed. Then the flashcard would go back into the pool and becomes a valid target for the program to randomly select.

When we originally conceived of the system, we asked students to indicate whether the card was correct or incorrect. We later realized that this was counterproductive. Some students are particularly sensitive to constantly being judged. Also, correct is a relative concept, not black or white. We then changed the interface to ask the students when they want to see the flashcard again, giving them five choices. Correct or incorrect was eliminated from the interface entirely. Incorrect was replaced with “Show again: Today.”

When the question comes up for review, the user is given the same five choices again (Show again: Today, A, B, C, or Never). Users that are not logged in would be unable to benefit from the functionality of having the system “remember” their review time selections. The values of A, B and C will be user modifiable.

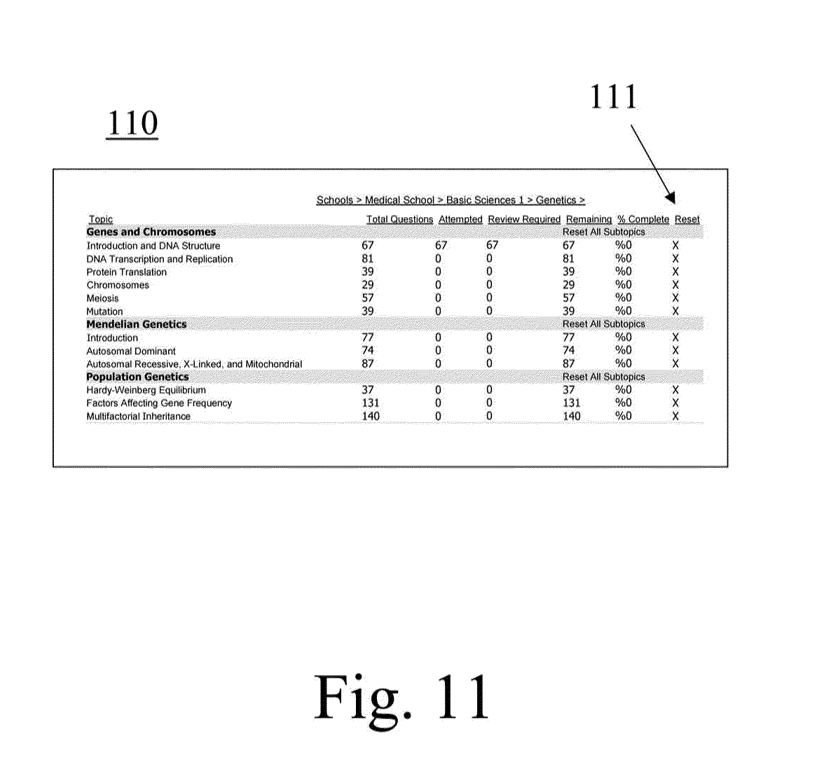

Each flashcard will also have a link to “subject review”. This will present the user with his/her progress 110 for the current subject as shown in FIG. 11. There will be options for students to “reset” subtopics 111 and essentially restore the questions of that Subtopic as though they had never answered a single question in the Subtopic.

Clicking the reset button described above would not immediately cause the reset to occur. Instead, a strong warning message would appear informing the user that this step is irreversible and asking the user if he wants to continue. The subject review should also include a print flashcard feature that will allow the user to print all of the cards in the subtopic for review away from the computer (or offline).

Users will be able to “Browse Flashcards.” They may click this button on any flashcard and see a list of all cards in that subtopic. They may click any card in the list to jump to that card. Upon browsing to a flashcard, the user would proceed from that flashcard when selecting next. For instance, if at flashcard #5, the user browsed to flashcard #10, the next card presented to the user (unless set to randomize cards) would be #11.

After choosing from the five options of when to view the flashcard again, the user would automatically be taken to the next question. If all questions for that Subtopic have been exhausted, he would be shown a relevant message along with links to other Subtopics in the subject.

Each flashcard will have links that would take users to various parts of the site such as the homepage of the public website, Subject Review, etc. They should be able to move to the home page of the static site from any flashcard. For every flashcard there would be two screens 80 and 90 as shown in FIGS. 8 and 9. One to display the question and the other for the answer 91. Each “side” of a flashcard would be both text and graphic in most circumstances. The text would appear on the left of the screen and the graphic on the right. If there is just text or just graphic, then the text or graphic would appear centered. Initially the screen showing the question 80 would appear. Only when the user clicks on the ‘Show Answer’ 82 link would the screen switch to show the answer 90. A ‘Show Question’ link 92 would take the user back to the question 80. Both screens would have a header 81 as shown: School> Term> Subject> Topic> Subtopic> Flashcard Number. Once the answer has been shown, both screens shall also have the “Show again: Today, A B, C, or Never” 93 links as shown in FIGS. 9 and 10.

Every flashcard will eventually have two voice files attached to it (one for the answer and one for the question) which would pronounce the question and answer for the student. This functionality will be available in two forms. For students who require/desire all cards to be read to them, there will be a user controlled setting/preference to read each card automatically. Upon viewing a card, the audio file will stream once. Upon clicking “Show Answer” the answer text will be played. Should the user decide to click ‘Show Question’, the question audio file will be played again. For all students, each card will have an icon that when pressed will stream the audio file for the card. This will be on the front and back of every card.

Each card will have an “edit flashcard” icon. Clicking this will open the express editor which is essentially a simple version of the bulk editor discussed below. The user will be presented with an editing view of both the front and back of the card. The user can edit the text and the graphics of the card. Hitting “Submit” will automatically send this card (in a container that is automatically named and created) to the managing editor where it will be treated in a manner similar to cards created by authors using the bulk editor (see below). Even before the edited card is reviewed by editors and eventually made visible to the rest of the users, the user who submitted the edit will see his/her card right away.

Each flashcard will have an “add new flashcard” button. Clicking this will essentially open the same express editor described above but there will be no pre-inserted text or graphics into the fields. Clicking update will send the card to the managing editors. If approved the card will be inserted into the spot after the card from which the editor was opened. After hitting “save” the user should be returned to the card they were originally viewing. If they proceed to the next card, they should see “their” new card (even though it isn't live for the rest of the users).

Each flashcard would also have an icon for feedback on both the question and answer screens. Clicking on this would open a popup window with a form where the user would be able to type his comments. This should be optionally anonymous. The user would see a note on the feedback form guaranteeing anonymity. A checkbox will toggle whether the feedback is anonymous. By default this box is NOT checked.

There would also be drop down menu options for ‘Unclear question’, ‘Unclear answer’, ‘I think the answer is wrong’ & ‘I like this type of question’. The exact text of these selections will be configurable by admins in the admin section of the site.

On submitting the form, an email containing the comments would be sent to the admin and the user would see a thank you message for the feedback. To maintain anonymity, the email would originate from the website, rather than the user's email account. This feature would be available to all users

Users that are logged in will have the ability to return to the last flashcard viewed from anywhere on the site. Clicking this link will enable students to return to the exact point in a subtopic they interacted with. Combined with the fact that all progress is charted and saved, students will be able to leave the site and return without ever losing data.

All web-pages (static and dynamic) on the site shall have a feedback link. This link will function in a similar way to the feedback link for flashcards. It will be a popup window with a drop down menu of feedback types and a comment box. The selectable feedback type will be configurable by administrators. All feedback emails sent to administrators should have a link to the flashcard or web-page from which the feedback originated. Administrators should be able to toggle whether they want to receive email notices when feedback has been submitted. Feedback should be listed on a separate page. Each feedback message would be linked to from this page. Each feedback will have the option for an admin to reply to the user who sent the feedback (if not anonymous). Upon replying to the feedback, an administrator will have the option of deleting the message. Users should get an email notice when someone has responded to their feedback. The notices could be toggled in options. Users should have an area where they can see a list of all feedback they have submitted.

At various points within the flashcard system, users will have the ability to see their progress through the system. This chart would tell users exactly where they stand with respect to all the Subtopics on the site. The chart would be exemplified as follows: The numbered Subtopics in the above progress chart would be links taking users directly to the questions of that Subtopic. For the most part, this progress chart can be restricted to the subject level. Since different Subtopics might have the same name, the corresponding Topic, Subject, Term, and School would appear to the left of each Subtopic to differentiate between them.

There will also be a need for a more global view of a user's progress, that is, how the user has progressed through a school or year. This functionality will need to be customizable (i.e. progress through school X and year Y, or only years 1 and 2 in school x). The tool should also provide a summary of the user's progress. This would basically be totals of all the columns in the above chart. Specifically, it would show the total number of questions in all the subtopics listed here, the number of questions attempted from these subtopics, the number of questions answered correctly, number of questions answered wrongly and the number of questions yet to be attempted. This summary would also be displayed graphically through charts and graphs. One chart would show the number of questions attempted from among the total number of questions. A second chart would show the number of questions answered correctly from among the number of questions attempted.

This entire progress chart (summary & subtopic breakup) would only display Subtopics which have been attempted by the user. However, this chart would have a link which would take the user to another chart which shows Subtopics not attempted by the user. Because the number of Subtopics in this chart might be too large to be easily displayed, it will require a filter; a drop-down menu containing Schools, Terms, etc. The user would select a School or Term and the chart would display non-attempted Subtopics for that Term. Here too each Subtopic would be a link taking the user directly to the questions of that Subtopic. Because this chart would only list subtopics which have not been attempted, there would be no utility of the summary results. Hence this would not be shown here.

A test would simply consist of questions (not to be confused with the ‘flashcard questions’). Within a test, questions would not be categorized. The tests would have either multiple-choice questions or true-false questions. Multiple choice tests could also be of the “pick all that apply” variety in which multiple answers are correct and required for credit. The questions and answers could be text, graphic, audio or any combination of the three. All questions in the test would be compulsory. Each test would have a passing score which would be determined by the admin.

When a user takes the test, he answers question number one, and upon doing so, a page would appear that shows the user either “correct” or “incorrect,” the correct answer, and a discussion about why the answer was the correct choice. This should appear regardless of whether the user answered correctly. This method makes it impossible to allow students to go back to questions later in the exam and may not be applicable in certain tests.

The tests would be scored by the application immediately upon completion and the results displayed to the user. The score would then be stored for accreditation purposes. The system will keep a permanent record of the score of each student.

There may be an additional feature allowing members to retake a particular test after a set amount of time. Some tests would not be eligible for retakes. Admins would configure when tests become available to students and how much time each test is permitted to take. The passing score for each test is admin configurable. Also, tests would be divided into “Families.” A family could have several exams in it. Each exam would be a different “version.”

All members, or volunteers, would be able to search for experts to form apprentice relationships at their locations. Similarly, experts too would be able to search for volunteers wishing to become apprentices. These members, or volunteers, shall be able to search for an expert based on the following criteria—specialty, sub-specialty, country, state, city & zip code (if in US). The volunteers would be able to browse through the entire list of experts matching the search criteria. Against each expert his name, address, phone, email, specialty, subspecialty, would be shown. Experts too would be able to search for a volunteer (member). Their search interface would be similar to that used by volunteers except that education and interests would replace specialty and subspecialty. Clicking on an expert would take the volunteer to a page showing further details of that expert. This would include medical school attended, residency training, year of graduation, board certification, licensure, abbreviated curriculum vitae, and areas of special interest or current research. An expert might not be only an individual but could also be an institution such as a clinic, hospital or a similar organization. In this case the person signing up would be the administrative supervisor representing the institution. The signup form for experts would have a place to indicate the same. Only an expert who has signed up may perform a search. Similarly, when an expert would be searching for a volunteer, he would be able to click on a volunteer from the search results and view the volunteer's details. Both volunteer and expert would not be able to store these search results for future reference.

The information about the experts would be entered by the experts themselves. They would do this through a form on the website which would ask them for this information. Before this they would have to register themselves with the site. This would enable them to login later and edit their information if required. Some fields will be required, and some optional. The admin would designate required fields. At any time the administrator would have access to remove an expert or edit his information. All volunteers would be members and so they would be able to enter their information through their Login area.

Authors would be the most junior of all administrative users. Their primary role would be to contribute flashcards and tests to the site. They would have been appointed by the administrator and would get their own username & password through which they would access the administrative panel.

Authors would have access to a Daily Activity Log where they would have to enter their day's activity. This would basically be a 2 column spreadsheet with the first column being for the date and the second for entering their day's activity. Even if the author does not enter his activity for a few days, the Log would still record those days and have a blank against the activity for those days. The log would be viewable and editable by the admin.

Tracking Form—This will allow authors to edit personal information including mailing addresses, items/software on loan, and phone numbers. This information is only accessible by the author and the administrator. An administrator or editor will write the review of an author's performance. An author will be able to access this page and add comments to a response section. The assessment itself will be viewable but not editable by the author.

Editors would be above authors and would also have additional responsibility. Besides their role of contributing questions and tests, they would also have to review and moderate all contributions made by authors under them. The reason for this is that authors would not be allowed to contribute ‘directly’ to the site. Editors too would be appointed by the admin and would get their own username & password to access the admin panel. They too would be assigned to certain subjects and topics within which they would have to work.

From among the editors, the administrator would nominate one or more people to be the Managing Editor (ME). The managing editors would be the hub through which all questions in the system would pass. They would control the flow of all flashcards and tests.

Each editor could be further classified such as Technical Editor, Grammatical Editor, or line editor. These labels would be functional and affect the automatic invoicing and card history. They would tell the administrator or ME which editor could perform which type of editorial duties. However, the system will be completely unable to prevent a technical editor from making a grammatical correction.

As with authors, editors too would be required to fill in a Daily Activity Log and a Tracking page. The Log would be identical to the author's Log. Additionally, the assessment feature would also apply to editors.

Once an author or editor is finished with certain flashcards, he would be able to submit them to the Managing Editor (ME). Once flashcards have been submitted to the ME, the ME could either accept the work as is or return it to an editor for corrections. The job of the ME is that of controlling the flow of flashcards in the system. No flashcard can go live without passing through the ME. This will hold true if the card is created by an author or any user.

When a batch of flashcards is submitted to an ME, they have the option of editing them themselves, sending them back to the same author or editor, sending them to another author or editor, deleting them entirely or making them live. Each flashcard container shall also have a comments area. When flashcards are moved from one administrative user to another, each person can enter their remarks in this area. These remarks would serve as instructions/comments to the next staff member receiving it. Clicking on the comment section of the container would cause the entire comment history to open. In addition to the container comments, each card itself will be able to have a comment associated with it. Commented cards will be differentiated in the main container view by a small icon. Hovering over this icon will display the entire comment. The administrator also will be able to perform the duty of an ME. This would serve as a backup in case the ME is unable to discharge his duties.

Editors and authors would also be able to export flashcards under their area. These flashcards would be exported to a file in CSV format. (CSV is a Comma Separated Value text file which is an accepted standard for storing data. It is very easy to import data from a CSV file into various applications such as Word and Excel.) This file would be used only for reference purposes. It would not be possible to import data into the system from these files. Each card will require two audio files to be associated with it.

Each user with author/editor status will have an automatic invoice generated upon certain conditions. Creating a new flashcard, modifying a graphic, or editing existing flashcards will all trigger invoice creation. The dollar amount of each type of item on the invoice will be configurable by admins. Credit will be given for new flashcard, new mnemonic flashcard, new image card (several types), minimal edit, major edit, scanned.

Auditors may review containers and generate an error report. This report lists all mistakes the auditor has found. A basic form of this will simply be a read-only version of the container that the original user may view. In this read-only version, the original user will be able to see icons for each card that has a comment attached to it. The user may click on each icon to see the comment and read about his error.

Admins/ME's can view a list of containers each user has and see the contents of each container. Administrators may also use the option to “Become User” for each account.

There will be editing statuses of each tier, configurable by manual input and exportable and printable. Examples of subtopic statuses include: No editing—has NOT been reviewed by any editors; Format edited—Has been reviewed by a grammar editor for mainly format purpose; Grammar edited—Has been reviewed by at least one grammar editor; Edited×2—Grammar and tech edited and revisions reviewed (individually, each card in the subtopic meets the standards); Complete—represents what tech editor views as complete coverage of the material; and Incomplete—does not present complete coverage of the material.

A Category Listings tool will be available to all users but will likely be of most use to admins and MEs. Selecting this module will enable admins to get a global sense of the status of the flashcard database. Every school, year, grade, subject and topic will be listed in a nested view along with the number of cards associated with each category level. The user will have the option to expand this list to display each subtopic as well. The numbers shown will be a dynamic reflection of the number of cards in the live database. Each category level will be a link to allow the user to go to that category.

The email center would be an admin only tool and would be used for communicating with the members of the site. The email center would capture the email addresses of all members of the site and the admin would then be able to sort them into email lists. Now the admin would be able to send an email to an individual member, members within a list, all members of a list or to all members of all lists.

All emails sent out would be archived in the email center for future reference. All emails would confirm to a standard template which would be in line with the look of the site. Although the email itself would be in html format having images, etc, the customized matter entered by the admin would only be in text format. The admin may enter html tags within the text for special formatting. A typical use of this email center shall be to periodically send out emails to users. Users will be allowed to opt in or out of any future emails sent from the email center.

Through the Auto-email manager within the admin panel the admin would be able to edit the content of the auto-emails that go out from the system. Auto-emails are those emails which are triggered by user activity in the front-end and are automatically sent out by the system without any admin intervention. In the Auto-email manager the admin would see a list of all the auto-emails in the system. By clicking on one he would be able to edit the static text in the email.

A Report Generator for Accreditation Agencies within the admin panel would generate reports of members for the benefit of accreditation agencies. These reports would contain all information of the student such as his profile, test scores, how many questions he has answered correctly, etc. Upon registration, the student would be informed of the potential for agencies having access to scores.

The content on the site will pass through several layers of editing before becoming “live” or viewable by the general public. In order to facilitate this, all editing or creating of cards will be done in holding areas known as containers. This is also true of tests and tier categories. Staff would each have their own containers that only they and the people above them have access to. For any changes to happen on the public site, staff must first send a container to the Managing Editor (ME)(or an admin). The ME will review the work or send it to an editor. After review and editorial response, the ME will add content to the publicly viewable database. To add content, the ME makes a container “Live.” This causes the container to disappear and the content to be written to the public database.

The Bulk Editor is the primary utility by which staff can write, edit, upload, audit, delete, and view flashcards. It is intended for large scale card production and is considerably more feature-rich than the express editor discussed below.

The Main Container Page will be the first page an author/editor/ME/admin sees when selecting the “containers” option. He will be presented with a list of all of his containers. He will see the container name (see below for naming scheme). He will also see how many flashcards are within the container. Lastly, the last comment attached to the container will also be visible. Clicking on the comment itself will open a window containing all the comments for the container. Clicking on the container name itself will select that container and bring the user into the container view. Admins will also have the ability to see containers owned by all other users.

From the Container view, a user will see a view of the contents of the container. The container name and owner will be presented. Also, the user will see when the container itself was last modified. This would represent the time/date when either the cards in the container were last modified, the container ownership was changed, or the container was renamed or commented.

Container view functions allow the admin to take the container (and the cards within it) so he can process/edit them (viewing the cards doesn't require ownership), writes all the additions, deletions, edits and changes in the container to the public database, erase the container and all of its contents. NONE of the changes in the container will take hold in the public database.

It is likely that heavy traffic to the site will lead to heavy use of the express editor. Unlike the cards submitted by authors, the user submitted cards may not be needed, wanted or meet the requirements of the site. Therefore, it was decided that these cards would be handled in such a way that allows the quick review of user submitted cards so that they can be quickly rejected or submitted for further review.

When admins/staff enter this module, they will be presented with a list of the user submitted cards. They are shown the new or edited text, the user that saved the card, and the subtopic the card is intended for. For each card an administrator has three choices:

All users will have the ability to suggest changes to the tier/category structure on the site. These suggestions will be subject to review by administrators before they are made live. Categories can be edited or created from any of the appropriate category browsing pages (i.e. to change a school name, the user must be at the school browsing page). Clicking the add new category icon or edit category icon links will open the same window with the following fields. It should be noted that the level of a particular category tier cannot be changed. In other words a school (school x) cannot be made into a subtopic. This is done to protect the integrity of the category levels below the edited category.

Furthermore, other areas of art may benefit from this method and adjustments to the design are anticipated. Thus, the scope of the invention should be determined by the appended claims and their legal equivalents, rather than by the examples given.

I claim:

1. A method of Internet learning accomplished by displaying flashcards for learning purposes in a computer, comprising the steps of:
(a) displaying a plurality of flashcards consisting of two sides, a first side with a question and a second side with an answer;
(b) providing a software system on said computer for tracking users on an individual level in a database;
(c) providing a multi-tiered classification system for the flashcards;
(d) completing subtopics;
(e) taking subsequent short-term learning tests;
(f) reviewing when necessary; and
(g) participating in ongoing learning for a plurality of weeks of learning.

2. The method of claim 1 wherein the multi-tiered classification system is comprised of five tiers: school, year, subject, topic, and subtopic each containing a plurality of flashcards.

3. The method of claim 2 further comprising the steps of:
(a) providing short-term multiple-choice tests at the end of each subtopic are used;
(b) presenting a random set of test questions to a user from the same tier;
(c) showing, immediately upon receiving an answer to a multiple-choice test question, the answer as well as an explanation;
(d) remembering responses to test questions;
(e) displaying infrequently test questions which were answered correctly; and
(f) displaying repeatedly test questions that were missed until they are answered correctly on multiple occasions.

4. The method of claim 3 further comprising the step of:
(a) presenting test questions from more than one subtopic and at random.

5. The method of claim 3 further comprising the steps of:
(a) displaying the status of a user;
(b) showing the grade level of the user for each subject;
(c) showing what the user has accomplished on a periodic basis; and
(d) tracking time spent on a periodic basis, number of flashcards viewed, number of flashcards answered correctly, long-term and short-term tests passed, test scores, as well as test questions answered correctly.

6. The method of claim 3 further comprising the step of:
(a) verifying the identity of the student via a fingerprint analyzer and 360° camera.

7. The method of claim 3 further comprising the steps of:
(a) completing a multiple-choice short-term learning test before moving to a new subtopic in the tested subject area;
(b) tracking short-term test results by the database; and
(c) returning a user to the subtopic flashcards for further review or progressing a user to the next subtopic based on the short-term learning test results.

8. The method of claim 7 further comprising the steps of:
(a) presenting long-term multiple-choice tests to the user;
(b) selecting a summative grouping of random questions weighted toward questions that have been previously answered incorrectly on short-term multiple-choice tests; and
(c) tracking long-term test results by the database.

9. The method of claim 8 further comprising the steps of:
(d) presenting retention tests to the user; and
(e) tracking retention test results by the database.

10. The method of claim 9 further comprising the steps of:
(a) custom-designing the retention tests to prioritize questions, targeting content that has been most frequently missed on previous exposures;
(b) presenting retention test questions at intervals of no less than two weeks; and
(c) considering the question mastered when said question is answered correctly on two consecutive occasions and removing the flashcard from the test.

11. The method of claim 10 further comprising the steps of:
(a) immediately explaining each incorrect answer on a test; and
(b) offering the opportunity to review the content material corresponding to an incorrect answer on a test.

12. The method of claim 9 further comprising the step of:
(a) administering long-term retention tests when two weeks or more have passed from the date a short-term assessment was successfully completed.
